(19) United States
(12) Patent Application Publication
(10) Pub. No.: US 2019/0123384 A1
(43) Pub. Date: Apr. 25, 2019

(54) SURFACE COATINGS FOR CERAMIC ELECTROLYTE PARTICLES

(71) Applicant: Seeo, Inc., Hayward, CA (US)

(72) Inventors: Katherine Joann Harry, Oakland, CA (US); Hany Basam Eitouni, Oakland, CA (US)

(21) Appl. No.: 16/218,416

(22) Filed: Dec. 12, 2018

Related U.S. Application Data
(63) Continuation-in-part of application No. 15/696,019, filed on Sep. 5, 2017.
Application No. 15/696,019 is a continuation of application No. PCT/US18/41528, filed on Jul. 10, 2018.

(51) Int. Cl. H01M 10/0565; H01M 10/052; H01M 2/16

(52) U.S. Cl. CPC H01M 10/0565; H01M 10/052; H01M 10/0567; H01M 2300/0085; H01M 2/16

(57) ABSTRACT

Core/shell ionically-conductive particles are disclosed. The core particles contain ceramic electrolyte materials, and the shells are electronically-conductive. The core/shell particles can be combined with organic electrolytes to form composite organic-ceramic electrolytes that can be used in lithium battery cells. Such composite organic-ceramic electrolytes have been found to have improved lithium transport properties when compared to similar composite electrolytes made with ceramic electrolyte particles that do not have electronically-conductive shells.

### CROSS-REFERENCE TO RELATED APPLICATIONS

This application is a Continuation of International Patent Application PCT/US18/41528, filed Jul. 10, 2018 and is also a Continuation-In-Part of U.S. patent application Ser. No. 15/696,019, filed Sep. 5, 2017, both of which are incorporated by reference herein.

### BACKGROUND OF THE INVENTION

### Field of the Invention

This invention relates generally to electrolytes, and, more specifically, to composite organic-ceramic electrolytes.

Single ion conducting ceramic electrolytes are of interest to the battery community because they have a high ionic conductivity and a Li⁺ transference number of one. This yields quick and efficient charge transport throughout the cell without the formation of concentration gradients. However, ceramics are brittle and tend to crack easily under the stresses of cell charge and discharge. Therefore, there is interest in developing composite organic-ceramic electrolytes that combine the outstanding transport properties of ceramic electrolytes with the straightforward processing of polymer or other organic electrolytes. Unfortunately, there is a large resistance to charge transport, as high as thousands of ohm cm², across the interface between organic electrolytes and ceramic electrolytes. With such high interfacial resistances, the ceramic electrolyte in a composite material does not make significant contributions to the transport of ions through the material but behaves more like an inert filler.

It would be useful to find a way to combine ceramic and organic electrolyte materials to produce composite organic-ceramic electrolytes that have low resistance to charge transport across the interfaces between these materials.

### SUMMARY

A composite organic-ceramic electrolyte is disclosed. The composite organic-ceramic electrolyte includes an organic electrolyte in which core/shell particles are dispersed. The core/shell particles have a core particle comprising an ionically-conductive ceramic electrolyte material that has a capacity less than 50 mAh/g between 3V and 4.5 V vs. Li/Li⁺, an electronic conductivity less than 10⁻⁶ S/cm at 30° C., and an ionic conductivity greater than 10⁻⁷ S/cm at 30° C. The core/shell particles also have an electronically-conductive outer shell around the core particle, and the electronically-conductive outer shell has an exterior surface that has an electronic conductivity greater than 0.1 S/cm at 30° C. In one arrangement, the ionic conductivity of the ceramic electrolyte is greater than the ionic conductivity of the organic electrolyte.

In one embodiment of the invention, the ceramic electrolyte may be any of lithium lanthanum titanates, lithium lanthanum zirconium oxides, lithium nitrides, lithium aluminas, lithium vanadium germanium oxides, lithium silicon aluminum oxides, lithium aluminum chlorides, lithium phosphorous oxy-nitrides, LISICON, lithium aluminum titanium phosphates, thio-LISICONs, lithium phosphorus sulfides, lithium germanium sulfides, or combinations thereof.

The organic electrolyte may be a solid polymer electrolyte, a gel electrolyte, or a liquid electrolyte.

In some arrangements, the solid polymer electrolyte includes an electrolyte salt and any of polyethers, polyamines, polyimides, polyamides, poly alkyl carbonates, polynitriles, perfluoro polyethers, polysiloxanes, polyalkoxysiloxanes, polyphosphazines, polyolefins, polydienes, polyesters, fluorocarbon polymers substituted with one or more groups selected from the group consisting of nitriles, carbonates, and sulfones, or combinations thereof. The solid electrolyte may have a molecular weight greater than 250 Da.

In some arrangements, the liquid electrolyte includes electrolyte salt and a solvent such as polyethylene glycol dimethyl ether (PEGDME), diethyl carbonate (DEC), ethylene carbonate (EC), propylene carbonate (PC), dimethylformamide (DMF), dimethylcarbonate, acetonitrile, succinonitrile, glutaronitrile, adiponitrile, or combinations thereof. In some arrangements, the liquid electrolyte includes electrolyte salt and an ionic liquid such as an alkyl substituted pyridinium-based ionic liquid, an alkyl substituted pryrolidinium-based ionic liquid, an alkyl substituted pryrolidinium-based ionic liquid, an alkyl substituted ammonium-based ionic liquid, and alkyl substituted piperidinium-based ionic liquid, or combinations thereof. Examples of anions that may be included in such ionic liquids include, but are not limited to, bis(trifluoromethane)sulfonamide (TFSI), fluoralkylphosphate (FAP), tetracyanoborate (TCB), bis(oxalato)borate (BOB), difluoro(oxalato)borate (DFOB), bis(fluorosulfonyl)imide (FSI), PF⁶, BF⁴ anions and combinations thereof.

There are no particular restrictions on the electrolyte salt that can be used in the organic electrolytes. Any electrolyte salt that includes a lithium ion can be used. It is especially useful to use electrolyte salts that have a large dissociation constant within the organic electrolyte. Examples of such salts include LiPF₆, LiN(CF₃SO₂)₂, LiN(FSO₂)₂, Li(CF₃SO₂)₃C, LiN(SO₂CF₂CF₃)₂, LiB(C₂O₄)₂, and mixtures thereof.

In one arrangement, the core/shell particles are approximately spherical and have average diameters between 10 nm and 100 μm.

In one embodiment of the invention, the electronically-conductive outer shell is an electronically-conductive ceramic. In some arrangements, the electronically-conductive ceramic is any of titanium nitride, zirconium nitride, titanium fluoride, titanium phosphide, zirconium phosphide, zirconium chloride, titanium chloride, titanium bromide, zirconium bromide, iron phosphide, indium tin oxide, lanthanum-doped strontium titanate, yttrium-doped strontium titanate, lithium nickel cobalt aluminum oxide, lithium nickel cobalt manganese oxide, or combinations thereof. In some arrangements, the electronically-conductive ceramic comprises nitrogen.

In some arrangements, the electronically-conductive outer shell includes any of carbon, platinum, gold, silver, titanium, nickel, chrome, copper, aluminum, or combinations thereof.

In some embodiments of the invention, the electronically-conductive outer shell is an electronically-conductive polymer that may be any poly(acetylene)s, poly(p-phenylene vinylene)s, poly(pyrrole)s, polycarbazoles, polyindoles, polyazepines, polyanilines, poly(thiophene)s, poly(p-phenylene sulfide)s, poly(fluorene)s, polyphenylenes, polypyrenes, polyazulenes, polynaphthalenes, or combinations thereof.

In one embodiment of the invention, a composite organic-ceramic electrolyte includes an organic electrolyte in which core/shell particles are dispersed. The core/shell particles have a lithium lanthanum titanate core and a titanium nitride shell around the core.

In some embodiments of the invention, a cathode includes cathode active material particles, an electronically-conductive additive, a catholyte, and an optional binder material, and a current collector adjacent to an outside surface of the cathode. The catholyte may be any of the composite organic-ceramic electrolytes disclosed herein.

In one arrangement, the cathode active material particles may be any of lithium iron phosphate, lithium manganese phosphate, lithium cobalt phosphate, lithium nickel phosphate, lithium nickel cobalt aluminum oxide, lithium nickel cobalt manganese oxide, high-energy lithium nickel cobalt manganese oxide, lithium manganese spinel, lithium manganese nickel spinel, sulfur, vanadium pentoxide, or combinations thereof.

In some embodiments of the invention an electrochemical cell includes an anode configured to absorb and release lithium ions, a cathode comprising cathode active material particles, an electronically-conductive additive, a first catholyte, and an optional binder material, a current collector adjacent to an outside surface of the cathode, and a separator region between the anode and the cathode. The separator region contains a separator electrolyte that is configured to facilitate movement of lithium ions back and forth between the anode and the cathode. The first catholyte may be any of the composite organic-ceramic electrolytes disclosed herein.

In one arrangement, the anode includes graphite, silicon or lithium titanate, and the separator electrolyte includes any of the composite organic-ceramic electrolytes disclosed herein.

In another arrangement, the anode includes lithium or lithium alloy foil, the separator electrolyte includes any of the composite organic-ceramic electrolytes electrolyte disclosed herein, and there is an anode overcoat layer adjacent to the anode. The anode overcoat layer includes an electrolyte that contains no core/shell ceramic electrolyte particles.

In one arrangement, there is a layer of second catholyte between the cathode and the separator electrolyte, and the second catholyte includes any of the composite organic-ceramic electrolytes disclosed herein. In one arrangement, the first catholyte and the second catholyte are the same.

In another arrangement, there is a layer of second catholyte between the cathode and the separator electrolyte, and the second catholyte layer comprises a ceramic electrolyte. The second catholyte layer may include one or more electronically-conductive surface layers, wherein the one or more electronically-conductive surface layers each has a thickness of 50 nm or less.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 is a schematic cross-section drawing of a core/shell ceramic electrolyte particle, according to an embodiment of the invention.

FIG. 2 is a schematic cross-section drawing of a composite organic-ceramic electrolyte, according to an embodiment of the invention.

FIG. 3 is a schematic cross-section drawing of a battery cell, according to an embodiment of the invention.

FIG. 4 is a schematic cross-section drawing of a battery cell, according to an embodiment of the invention.

FIG. 5 is a schematic cross-section drawing of a battery cell, according to an embodiment of the invention.

FIG. 6 is a schematic cross-section drawing of a battery cell, according to an embodiment of the invention.

FIG. 7 is Nyquist plot that shows AC impedance spectra for two lithium symmetric cells, according to an embodiment of the invention.

### DETAILED DESCRIPTION

The embodiments of the invention are illustrated in the context of composite organic-ceramic electrolytes for lithium battery cells.

All ranges disclosed herein are meant to include all ranges subsumed therein unless specifically stated otherwise. As used herein, “any range subsumed therein” means any range that is within the stated range.

In this disclosure, the terms “negative electrode” and “anode” are both used to mean “negative electrode”. Likewise, the terms “positive electrode” and “cathode” are both used to mean “positive electrode”.

It is to be understood that the terms “lithium metal” or “lithium foil,” as used herein with respect to negative electrodes, are meant to include both pure lithium metal and lithium-rich metal alloys as are known in the art. Examples of lithium rich metal alloys suitable for use as anodes include Li—Al, Li—Si, Li—Sn, Li—Hg, Li—Zn, Li—Pb, Li—C, Li—Mg or any other Li-metal alloy suitable for use in lithium metal batteries. Other negative electrode materials that can be used in the embodiments of the invention include materials in which lithium can intercalate, such as graphite.

The term “organic electrolyte” is used throughout this disclosure. It should be understood that such organic electrolytes include organic liquid, gel and solid electrolytes. Some such electrolytes may be polymers, and some may not. Gel electrolytes may contain polymers combined with one or more liquid electrolytes. In a gel electrolyte, the polymer(s) may or may not itself be an electrolyte. It should be understood that such organic electrolytes usually contain electrolyte salts, such as lithium salts, even if it is not stated explicitly. There are no particular restrictions on the electrolyte salt that can be used in the organic electrolytes. Any electrolyte salt that includes a lithium ion can be used. It is especially useful to use electrolyte salts that have a large dissociation constant within the organic electrolyte. Examples of such salts include LiPF₆, LiN(CF₃SO₂)₂, LiN(FSO₂)₂, Li(CF₃SO₂)₃C, LiN(SO₂CF₂CF₃)₂, LiB(C₂O₄)₂, and mixtures thereof.

Many embodiments described herein are directed to electrolytes that contain ionically-conductive, solid polymer electrolytes. In various arrangements, the solid polymer electrolyte may be a dry polymer electrolyte, a block copolymer electrolyte and/or a non-aqueous electrolyte. Organic liquid and gel polymer electrolytes can also be used in the embodiments of the invention, either alone as a separator electrolyte in a lithium battery cell or as a component of a composite organic-ceramic electrolyte, according to embodiments of the invention. As is well known in the art, batteries with organic liquid electrolytes may be used with an inactive separator membrane that is distinct from the organic liquid electrolyte.

It is to be understood that the term “ceramic electrolyte” as used herein is used to refer to ceramic materials that have a capacity less than 50 mAh/g between 3V and 4.5 V vs. Li/Li⁺, an electronic conductivity less than 10⁻⁶ S/cm at room temperature (30° C.), and an ionic conductivity greater than 10⁻⁷ S/cm at room temperature (30° C.). In other arrangements, a ceramic electrolyte has an ionic conductivity greater than 10⁻⁶ S/cm, greater than 10⁻⁵ S/cm, greater than 10⁻⁴ S/cm, or greater than 10⁻³ S/cm at room temperature (30° C.). In various arrangements, the lithium ion diffusion coefficient of a ceramic electrolyte is greater than 1×10⁻¹⁴ m²/s, greater than 1×10⁻¹³ m²/s, or greater than 1×10⁻¹² m²/s at 30° C.

Electrolytes with a high ionic conductivity, a transference number close to one, and good electrochemical stability at voltages larger than 4.0 V are useful for improving the charge and discharge rate performance of high energy density electrochemical cells. A variety of ceramic electrolytes, including lithium lanthanum titanates (LLTO), lithium lanthanum zirconium oxides (LLZO), lithium ion conducting glass ceramics (e.g., lithium aluminum titanium phosphate (LATP) and lithium phosphorous oxy-nitride (LiPON)), and others have outstanding transport properties and stability at elevated voltages. Such properties are especially useful in a cathode of an electrochemical cell, where enhanced ionic transport may make it possible to use a thicker cathode and thus increase the energy density of the cell.

In one embodiment of the invention, composites of lithium-ion-conducting ceramic and organic electrolyte materials make superior electrolytes for use in lithium batteries. Ceramic material particles provide high conductivity pathways for lithium-ions, enhancing the conductivity of such a composite organic-ceramic electrolyte as compared to less ionically-conductive organic electrolyte material alone. The organic electrolyte material provides flexibility, binding, and space-filling properties, mitigating the tendency of rigid ceramic materials to break or delaminate. Materials and techniques that reduce the resistance to charge transport across the interface between organic electrolytes and ceramic electrolytes are disclosed herein.

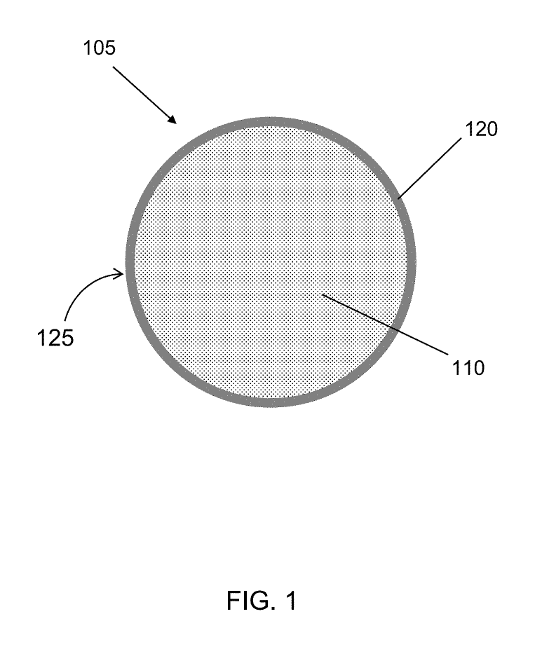

In one embodiment of the invention, a core/shell ceramic electrolyte particle has an outer shell whose electronic conductivity is greater than the electronic conductivity of the interior of the particle. Such a core/shell ceramic electrolyte particle 105 is shown in cross section in the schematic drawing in FIG. 1. The core/shell ceramic electrolyte particle 105 has a ceramic electrolyte core particle 110 that is ionically conductive, and an outer shell 120 that is electronically-conductive. In various arrangements, the ionic conductivity of the ceramic electrolyte core particle 110 is greater than 1×10⁻⁷ S/cm, greater than 1×10⁻⁵ S/cm, greater than 1×10⁻³ S/cm, or any range subsumed therein at room temperature (30° C.). In various arrangements, the electronic conductivity at the outer shell is greater than 1×10⁻⁴ S/cm, greater than 1×10⁻³ S/cm, greater than 1×10⁻² S/cm, greater than 0.1 S/cm, greater than 10 S/cm, greater than 50 S/cm, greater than 100 S/cm, greater than 1000 S/cm, greater than 10,000 S/cm, or any range subsumed therein at room temperature (30° C.). When such core/shell ceramic electrolyte particles are used in composite organic-ceramic electrolytes, they have been shown to have reduced interfacial resistance as compared with ceramic electrolyte particles that do not have enhanced electronic conductivity on their outer surfaces (i.e., with no shell that has higher electronic conductivity than the ceramic electrolyte).

In various embodiments of the invention, the core/shell ceramic electrolyte particles are approximately spherical or equiaxed and have an average diameter between 10 nm and 100 μm, between 300 nm and 10 μm, between 500 nm and 2 μm, or any range subsumed therein. In various embodiments of the invention, the shell thickness of the core/shell ceramic electrolyte particle is between 1 nm and 50 nm, between 2 nm and 30 nm, between 5 nm and 10 nm, or any range subsumed therein. In one embodiment, the shell is continuous and covers all or nearly all of the surface of the core particle. In other embodiments, the shell is discontinuous and covers between 75% and 50% of the surface of the core particle, between 50% and 25% of the surface of the core particle, or any range subsumed therein.

Examples of ceramic electrolyte materials that can be used as the core for core/shell particles in the embodiments of the invention include, but are not limited to, materials listed in Table I below. In some embodiments of the invention the core in a core/shell particle has a crystalline morphology, and in some embodiments the core in a core/shell particle has an amorphous or glass morphology.

TABLE I
Exemplary Ceramic Electrolyte Materials

| Ceramic Electrolyte Type | Exemplary Formula(s) |
|---|---|
| Lithium lanthanum titanates | Li₃ₓLa_{(2/3)-x}TiO₃ |
| Lithium lanthanum zirconium oxides | Li_{w}LaₓZr_{y}O_{z} |
| | (e.g., Li₇La₃Zr₂O₁₂) |
| Lithium nitrides | Li₃N |
| Lithium aluminas | LiAl₅O₈ |
| | Li₅AlO₄ |
| | LiAlO₂ |
| Lithium vanadium germanium oxides | Li_{w}VₓGe_{y}O_{z} |
| | (e.g., Li_{3.6}V_{0.4}Ge_{0.6}O₄) |
| Lithium silicon aluminum oxides | Li_{w}SiₓAl_{y}O_{z} |
| | (e.g., Li₉SiAlO₈) |
| Lithium aluminum chlorides | LiAlCl₄ |
| Lithium phosphorous oxy-nitrides | LiₓPO_{y}N_{z} |
| (LiPON) | |
| Lithium super ionic conductors | Li_{w}ZnₓGe_{y}O_{z} |
| (LISICON) | (e.g., Li₁₄ZnGe₄O₁₆) |
| Lithium aluminum titanium | LiₓTi_{y}Al_{z}(PO₄)₃ |
| phosphates | (e.g., Li_{1.3}Ti_{1.7}Al_{0.3}(PO₄)₃) |
| Lithium aluminum germanium | LiₓGe_{y}Al_{z}(PO₄)₃ |
| phosphates | (e.g., |
| | Li_{1.5}Ge_{1.5}Al_{0.5}(PO₄)₃) |
| Thio-LISICONs | Li_{3.25}Ge_{0.25}P_{0.75}S₄ |
| | Li₁₀GeP₂S₁₂ |
| | Li₁₀SnP₂S₁₂ |
| | Li₁₀SiP₂S₁₂ |
| Lithium phosphorus sulfides | Li₇P₃S₁₁ |
| | γ-Li₃PS₄ |
| Lithium germanium sulfides | Li₄GeS₄ |

As shown in Table I above, lithium lanthanum titanate (LLTO) can be described by the formula, Li₃ₓLa_{(2/3)-x}TiO₃. In various arrangements, the values of x are given by 0<x<0.7, 0.02<x<0.30, 0.04<x<0.17, or 0.09<x<0.13. Various other ceramic electrolyte materials in Table I are shown as having chemical formulas in which the stoichiometries are shown with variables such as w, x, y, and z. As would be understood by a person with ordinary skill in the art, each of the compounds listed in Table I may have a variety of stoichiometries. Those shown in Table I are meant to be examples only. It should be understood that the examples in Table I are representative only, and that the invention is not limited by any particular values of the stoichiometric variables.

In some embodiments of the invention, any of the ceramics listed in Table I also contains one or more of a variety of dopants. A list of exemplary dopants is shown below:

| | | | |
|---|---|---|---|
| sodium | magnesium | aluminum | potassium |
| calcium | chromium | manganese | iron |
| gadolinium | germanium | rubidium | strontium |
| yttrium | zirconium | niobium | ruthenium |
| silver | barium | praseodymium | neodymium |
| samarium | europium | terbium | dysprosium |
| hafnium | tantalum | tungsten | thallium |

In some embodiments of the invention, electronically-conductive ceramic materials are used as the shells in the core/shell particles disclosed herein. Examples of such electronically-conductive ceramic materials include, but are not limited to, materials listed in Table II below. In some embodiments of the invention, the electronically-conductive ceramic material used in the shells in the core/shell particles disclosed herein is a material that has properties that may also make it useful as a cathode active material. In one embodiment of the invention the shell in a core/shell particle has a crystalline morphology, and in some embodiments the shell in a core/shell particle has an amorphous or glass morphology.

TABLE II
Exemplary Electronically-Conductive
Ceramic Shell Materials

| Ceramic Type | Exemplary Formula(s) |
|---|---|
| Titanium nitride | TiN, Ti₂N, Ti₃N, Ti₄N₃₋ₓ, |
| | Ti₁₉N₂₅ |
| Zirconium nitride | ZrN, Zr₂N |
| Titanium fluoride | TiF₃ |
| Titanium phosphide | Ti₃P, TiP |
| Zirconium phosphide | ZrP, Zr₃P |
| Zirconium chloride | ZrCl₃, ZrCl |
| Titanium chloride | TiCl₃, TiCl₂ |
| Titanium bromide | Ti₃Br, TiBr₃ |
| Zirconium bromide | ZrBr, ZrBr₃, ZrBr₂ |
| Iron phosphide | FeP, Fe₂P, Fe₃P |
| Indium tin oxide | In₂O₃—SnO₂ |
| Lanthanum-doped strontium | LaₓSr₁₋ₓTiO₃ |
| titanate | (0.1 < x < 0.4) |
| Yttrium-doped strontium | Y_{0.08}Sr_{0.92}TiO₃ |
| titanate | |
| Lithium Nickel Cobalt | LiNiCoAlO₂ |
| Aluminum Oxide (NCA) | |
| Lithium Nickel Cobalt | LiNiCoMnO₂ |
| Manganese Oxide (NMC) | |

In one embodiment of the invention, the ceramic electrolyte core particle 110 is sintered in a nitrogen environment to form the outer shell 120. In some arrangements, the outer shell 120 is formed from reaction of nitrogen with the ceramic electrolyte core particle material to form a new nitrogen-containing phase. In some arrangements, the outer shell 120 is formed from diffusion of nitrogen into the surface of the ceramic electrolyte core particle 110 to form a nitrogen-doped region. In an exemplary embodiment, a core particle of lithium lanthanum titanate (LLTO) is sintered in nitrogen, which produces either a nitrogen-doped LLTO shell or a shell of another phase such as TiN. Examples of other gases that can be used as environments for sintering ceramic electrolyte core particles to produce electronically-conductive outer shells include, but are not limited to, nitrogen, ammonia, hydrogen, chlorine-containing gases, fluorine-containing gases, phosphorus-containing gases, bromine-containing gases, and iodine-containing gases, either alone or combined with inert gas.

Although the schematic drawing in FIG. 1 shows a sharp boundary between the ceramic electrolyte core particle 110 and the outer shell 120 of the core/shell ceramic electrolyte particle 105, it should be understood that diffuse boundaries are also possible. In some arrangements, there is a gradient of electronically-conductive material within the outer shell 120. For example, the outermost surface 125 may contain electronically-conductive material that has the highest electronic conductivity (and lowest ionic conductivity), and the electronic conductivity (ionic conductivity) may decrease (increase) within the outer shell 120 as one gets closer to the ceramic electrolyte core particle 110.

In some embodiments of the invention, the outer shell 120 is applied to the ceramic electrolyte core particle 110 by sputtering an electronically-conductive ceramic material. Examples of materials that can be used to coat the particles include, but are not limited to, those shown in Table II above.

In some embodiments of the invention, the outer shell 120 is applied to the ceramic electrolyte core particle 110 using a sol-gel technique. For example, metal alkoxides, such as titanium(IV) tert-butoxide or tetraethyl orthosilicate, can dissolve in a solvent and form a gel. Core particles are suspended in the gel. The solvent can be removed and the core particles heated to remove the organic components, allowing a coating to densify and/or crystallize into a ceramic outer shell 120.

In some embodiments of the invention, the electronically-conductive outer shell 120 is applied to the ceramic electrolyte core particle 110 using mechanical milling. Through mechanical impaction, the electronically-conductive material is applied and adhered to the surface of the ceramic electrolyte core particle.

In other embodiments of the invention, other kinds of electronically-conductive materials are used as the outer shell 120 in the core/shell ceramic electrolyte particle 105 disclosed herein. For example, carbon or metals such as platinum, gold, silver, titanium, nickel, chrome, copper, aluminum, or combinations thereof may be used. Such materials may be applied to the ceramic electrolyte core particle 110 by sputtering, evaporation, or other metal and carbon coating methods.

In one arrangement, electronically-conductive polymers such as poly(acetylene)s, poly(p-phenylene vinylene)s, poly(pyrrole)s, polycarbazoles, polyindoles, polyazepines, polyanilines, poly(thiophene)s, poly(p-phenylene sulfide), poly(fluorene)s, polyphenylenes, polypyrenes, polyazulenes, polynaphthalenes, or combinations thereof are used as the outer shell 120 in the core/shell ceramic electrolyte particle 105 disclosed herein. Such materials may be dissolved in a solvent and applied to core particles by dipping the particles into the solution and evaporating the solvent.

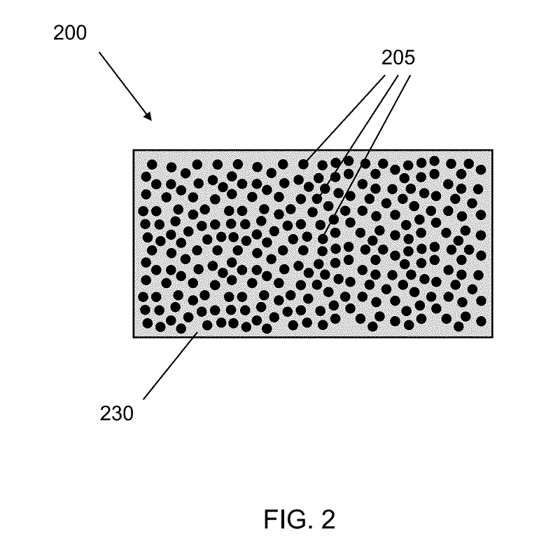

In one embodiment of the invention the core/shell ceramic electrolyte particles disclosed above can be mixed with an organic electrolyte to form a composite organic-ceramic electrolyte that has improved ionic transport properties and electrochemical stability in a battery cell, as compared to the organic electrolyte alone. Such a composite organic-ceramic electrolyte 200 is shown in cross section in the schematic drawing in FIG. 2. The composite organic-ceramic electrolyte 200 contains core/shell ceramic electrolyte particles 205, as seen in FIG. 1, distributed within a solid, gel, or liquid organic electrolyte 230.

In one embodiment of the invention, the organic electrolyte 230 is any ionically-conductive solid polymer that is appropriate for use in a Li battery. Examples of such solid polymer electrolytes include, but are not limited to, homopolymers, random copolymers, graft copolymers, and block copolymers that contain ionically-conductive blocks and structural blocks that make up ionically-conductive phases and structural phases, respectively. The ionically-conductive polymers or phases may contain one or more linear or non-linear polymers such as polyethers, polyamines, polyimides, polyamides, poly alkyl carbonates, polynitriles, perfluoro polyethers, polysiloxanes, polyalkoxysiloxanes, polyphosphazines, polyolefins, polydienes, polyesters, and fluorocarbon polymers substituted with high dielectric constant groups such as nitriles, carbonates, and sulfones, and combinations thereof. The linear polymers can also be used in combination as graft copolymers with polysiloxanes, polyalkoxysiloxanes, polyphosphazines, polyolefins, and/or polydienes to form the conductive phase. The structural phase may be made of polymers such as polystyrene, hydrogenated polystyrene, polymethacrylate, poly(methyl methacrylate), polyvinylpyridine, polyvinylcyclohexane, polyimide, polyamide, polypropylene, polyolefins, poly(t-butyl vinyl ether), poly(cyclohexyl methacrylate), poly(cyclohexyl vinyl ether), poly(t-butyl vinyl ether), polyethylene, poly(phenylene oxide), poly(2,6-dimethyl-1,4-phenylene oxide) (PXE), poly(phenylene sulfide), poly(phenylene sulfide sulfone), poly(phenylene sulfide ketone), poly(phenylene sulfide amide), polysulfone, fluorocarbons, such as polyvinylidene fluoride, or copolymers that contain styrene, methacrylate, or vinylpyridine. It is especially useful if the structural phase is rigid and is in a glassy or crystalline state. In various arrangements, the polymer electrolyte 230 has a molecular weight greater than 250 Da, or greater than 20,000 Da, or greater than 100,000 Da.

In some embodiments of the invention, the organic electrolyte 230 is any ionically-conductive organic liquid electrolyte that is appropriate for use in a Li battery. In some arrangements, liquid electrolytes that can be used in a composite organic-ceramic electrolyte include, but are not limited to, solvents with electrolyte salts, ionic liquids with electrolyte salts, and combinations thereof. In general, organic electrolytes may be used in combination to form electrolyte mixtures. As is well known in the art, batteries with organic liquid electrolytes may be used with an inactive separator membrane that is distinct from the organic liquid electrolyte. Some examples of such solvents and ionic liquids are shown in Table III.

TABLE III
Exemplary Organic Liquid Electrolytes
Solvents (to which electrolyte salt is added)

| | | |
|---|---|---|
| polyethylene glycol | propylene carbonate (PC) | succinonitrile |
| dimethyl ether (PEGDME) | dimethylformamide (DMF) | glutaronitrile |
| diethyl carbonate (DEC) | dimethylcarbonate | adiponitrile |
| ethylene carbonate (EC) | acetonitrile | |

Ionic liquids (to which electrolyte salt is added)

| | |
|---|---|
| alkyl substituted pyridinium-based | alkyl substituted ammonium-based |
| ionic liquids | ionic liquids |
| alkyl substituted pryrolidinium- | alkyl substituted piperidinium-based |
| based ionic liquids | ionic liquids |
| alkyl substituted pryrolidinium- | |
| based ionic liquids | |

There are no particular restrictions on the electrolyte salt that can be used with the solvents and ionic liquids listed in Table III above. Any electrolyte salt that includes a lithium ion can be used. It is especially useful to use electrolyte salts that have a large dissociation constant within the organic electrolyte. Examples of such salts include LiPF₆, LiN(CF₃SO₂)₂, LiN(FSO₂)₂, Li(CF₃SO₂)₃C, LiN(SO₂CF₂CF₃)₂, LiB(C₂O₄)₂, and mixtures thereof.

Examples of anions that can be included in the ionic liquids listed in Table III above include, but are not limited to, bis(trifluoromethane)sulfonamide (TFSI), fluoralkylphosphate (FAP), tetracyanoborate (TCB), bis(oxalato)borate (BOB), difluoro(oxalato)borate (DFOB), bis(fluorosulfonyl)imide (FSI), PF₆, BF₄ anions and combinations thereof.

In some embodiments of the invention, the organic electrolyte 230 is any ionically-conductive gel electrolyte that is appropriate for use in a Li battery. Examples of gel electrolytes that can be used in a composite organic-ceramic electrolyte include, but are not limited to, polymers such as polyethylene oxide (PEO), polyacrylonitrile (PAN), poly(methyl methacrylate) (PMMA), poly(vinylidene fluoride) (PVDF), poly(vinyl pyrrolidinone) (PVP), poly(vinyl acetate) (PVAC), poly(vinylidene fluoride)-co-hexafluoropropylene (PVDF-HFP), and combinations thereof mixed with a liquid electrolyte such as those listed above.

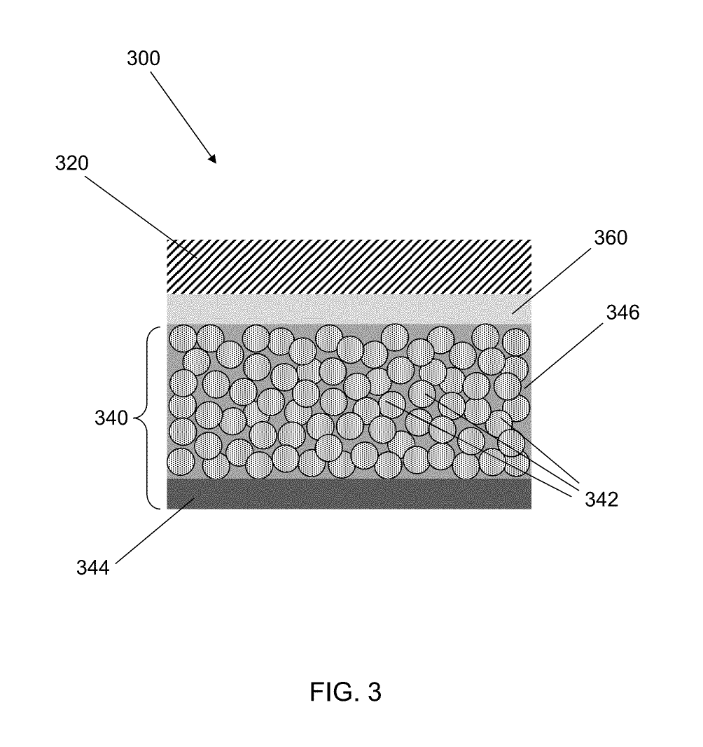

In one embodiment of the invention, the composite organic-ceramic electrolytes disclosed herein are used as catholytes in lithium battery cells. With reference to FIG. 3, a lithium battery cell 300 has an anode 320 that is configured to absorb and release lithium ions. The anode 320 may be a lithium or lithium alloy foil or it may be made of a material into which lithium ions can be absorbed and released, such as graphite, silicon, or lithium titanate. The lithium battery cell 300 also has a cathode 340 that includes cathode active material particles 342, an optional electronically-conductive additive (not shown), a current collector 344, a catholyte 346, and an optional binder (not shown). The catholyte 346 may be any of the composite organic-ceramic electrolytes disclosed here. There is a separator region 360 between the anode 320 and the cathode 340. The separator region 360 contains an electrolyte that facilitates movement of lithium ions back and forth between the anode 320 and the cathode 340 as the cell 300 cycles. The separator region 360 may include any electrolyte that is suitable for such use in a lithium battery cell. In one arrangement, the separator region 360 contains a porous plastic separator material that is soaked with a liquid electrolyte. In another arrangement, the separator region 360 contains a liquid (in combination with an inactive separator membrane) or gel electrolyte. In another arrangement, the separator region 360 contains a solid polymer electrolyte. In another arrangement, the separator region 360 contains a ceramic electrolyte or a composite organic-ceramic electrolyte.

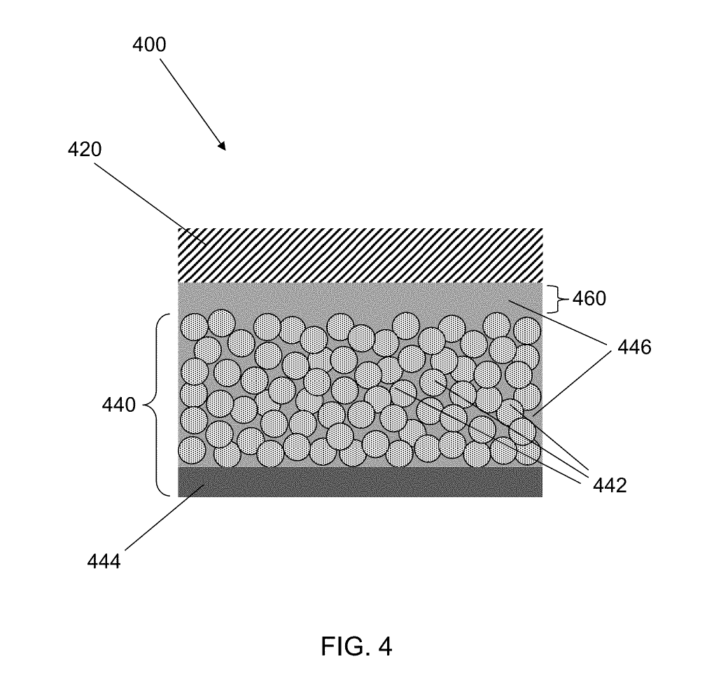

In some embodiments of the invention, a battery cell with a second configuration is described. With reference to FIG. 4, a lithium battery cell 400 has an anode 420 that is configured to absorb and release lithium ions. The anode 420 may be made of a material into which lithium ions can be absorbed and released, such as graphite, silicon, or lithium titanate. The lithium battery cell 400 also has a cathode 440 that includes cathode active material particles 442, an optional electronically-conductive additive (not shown), a current collector 444, a catholyte 446, and an optional binder (not shown). The catholyte 446 may be any of the composite organic-ceramic electrolytes disclosed here. There is a separator region 460 between the anode 420 and the cathode 440. The catholyte 446 extends from the cathode 440 into the separator region 460 and facilitates movement of lithium ions back and forth between the anode 420 and the cathode 440 as the cell 400 cycles. In one arrangement, the catholyte 440 is a liquid composite organic-ceramic electrolyte and it is used in combination with an inactive separator membrane (not shown) in the separator region 460.

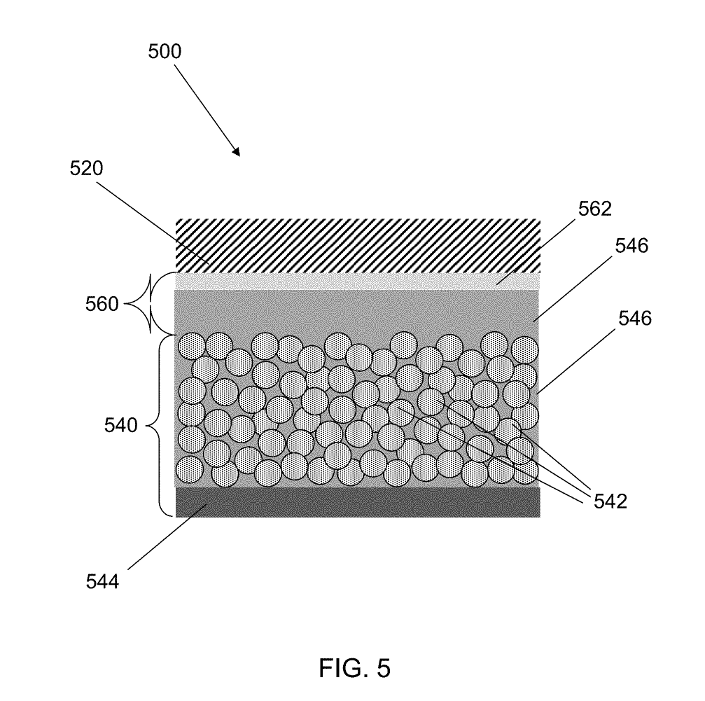

In some embodiments of the invention, a battery cell with a third configuration is described. With reference to FIG. 5, a lithium battery cell 500 has an anode 520 that is configured to absorb and release lithium ions. The anode 520 may be a lithium or lithium alloy foil or it may be made of a material into which lithium ions can be absorbed and released, such as graphite, silicon, or lithium titanate. The lithium battery cell 500 also has a cathode 540 that includes cathode active material particles 542, an optional electronically-conductive additive (not shown), a current collector 544, a catholyte 546, and an optional binder (not shown). The catholyte 546 may be any of the composite organic-ceramic electrolytes disclosed here. There is a separator region 560 between the anode 520 and the cathode 540. The catholyte 546 extends into the separator region 560. In one arrangement, the catholyte 546 is a liquid composite organic-ceramic electrolyte and it is used in combination with an inactive separator membrane (not shown) in the separator region 560. The separator region 560 also contains an anode overcoat layer 562 adjacent to the anode 520, which contains an electrolyte that is different from the catholyte 546. The anode overcoat layer 562 may include any other electrolyte that is suitable for such use in a lithium battery cell. In one arrangement, the anode overcoat layer 562 contains an inactive separator membrane (not shown) that is soaked with a liquid electrolyte. In another arrangement, the anode overcoat layer 562 contains a gel electrolyte. In another arrangement, the anode overcoat layer 562 contains a solid polymer electrolyte. In another arrangement, the anode overcoat layer 562 contains no ceramic electrolyte particles. The electrolytes in the separator region 560 facilitate movement of lithium ions back and forth between the anode 520 and the cathode 540 as the cell 500 cycles.

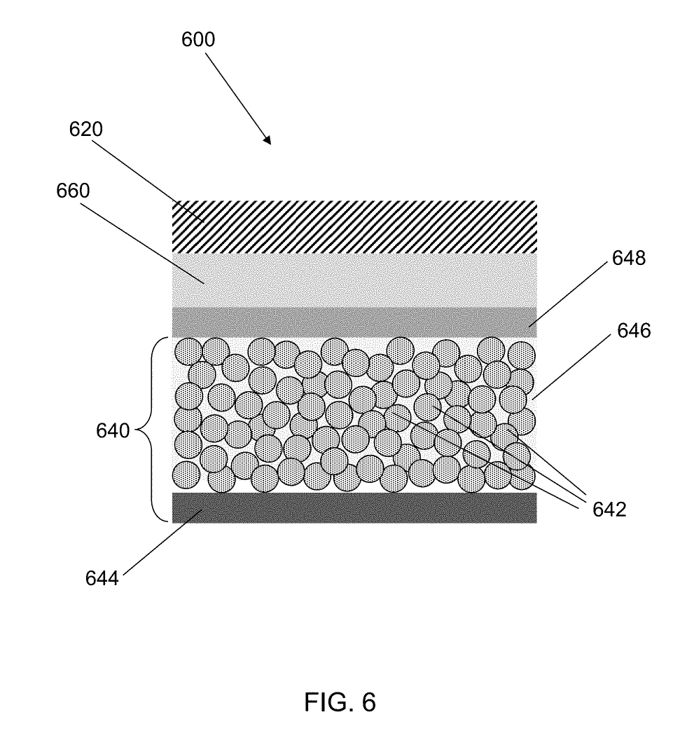

In some embodiments of the invention, a battery cell with a fourth configuration is described. With reference to FIG. 6, a lithium battery cell 600 has an anode 620 that is configured to absorb and release lithium ions. The anode 620 may be a lithium or lithium alloy foil or it may be made of a material into which lithium ions can be absorbed and released, such as graphite, silicon, or lithium titanate. The lithium battery cell 600 also has a cathode 640 that includes cathode active material particles 642, an optional electronically-conductive additive (not shown), a current collector 644, a catholyte 646, an optional binder (not shown). There is a cathode overcoat layer 648 between the cathode 640 and a separator region 660. The catholyte 646 may be any of the electrolytes disclosed here, including composite organic-ceramic electrolytes, or any other electrolyte appropriate for use as a catholyte in a lithium battery cell.

The cathode overcoat layer 648 comprises a single-ion conducting material that allows transport of Li⁺ ions, but not anions, such as any of the ionically-conductive ceramic materials listed in Table I. In one arrangement, the cathode overcoat layer 648 also has one or more electronically-conductive surface layers (not shown). One such electronically-conductive surface layer may be on the surface of the cathode overcoat layer 648 that faces the cathode 640. Another such electronically-conductive surface layer may be on the surface of the cathode overcoat layer 648 that faces the separator region 660. The electronically-conductive surface layer(s) may include, for example, any of the electronically-conductive materials disclosed herein, such as those listed in Table II. In one arrangement, the electronically-conductive surface layer(s) on layer 648 have a thickness of 50 nm or less. The separator region 660 is between the anode 620 and the cathode overcoat layer 648. The separator region 660 contains an electrolyte that facilitates movement of lithium ions back and forth between the anode 620 and the cathode 640 as the cell 600 cycles. The separator region 660 may include any electrolyte that is suitable for such use in a lithium battery cell. In one arrangement, the separator region 660 contains an inactive separator membrane that is soaked with a liquid electrolyte. In another arrangement, the separator region 660 contains a viscous liquid or gel electrolyte. In another arrangement, the separator region 660 contains a solid polymer electrolyte. In another arrangement, the separator region 660 contains a ceramic electrolyte or a composite organic-ceramic electrolyte, according to embodiments of the invention.

With respect to the embodiments discussed in FIGS. 3, 4, 5, and 6, suitable cathode active materials include, but are not limited to, lithium iron phosphate (LFP), lithium metal phosphate (LMP) in which the metal can be manganese, cobalt, or nickel, lithium nickel cobalt aluminum oxide (NCA), lithium nickel cobalt manganese oxide (NCM), high-energy NCM, lithium manganese spinel, lithium manganese nickel spinel, sulfur, vanadium pentoxide, and combinations thereof. Suitable electronically-conductive additives include, but are not limited to, carbon black, graphite, vapor-grown carbon fiber, graphene, carbon nanotubes, and combinations thereof. A binder can be used to hold together the cathode active material particles and the electronically-conductive additive. Suitable binders include, but are not limited to, PVDF (polyvinylidene difluoride), PVDF-HFP (poly(vinylidene fluoride-co-hexafluoropropylene)), PAN (polyacrylonitrile), PAA (polyacrylic acid), PEO (polyethylene oxide), CMC (carboxymethyl cellulose), SBR (styrene-butadiene rubber), and combinations thereof.

With respect to the embodiments discussed in FIGS. 3, 4, 5, and 6, solid polymer electrolytes for use in separator regions 360, 460, 560, 660, and as the anode overcoat layer 562 can be any such electrolyte that is appropriate for use in a Li battery. Of course, many such electrolytes also include electrolyte salt(s) that help to provide ionic conductivity. Examples of such solid polymer electrolytes include, but are not limited to, homopolymers, random copolymers, graft copolymers, and block copolymers that contain ionically-conductive blocks and structural blocks that make up ionically-conductive phases and structural phases, respectively. The ionically-conductive polymers or phases may contain one or more linear or non-linear polymers such as polyethers, polyamines, polyimides, polyamides, poly alkyl carbonates, polynitriles, perfluoro polyethers, polysiloxanes, polyalkoxysiloxanes, polyphosphazines, polyolefins, polydienes, polyesters, and fluorocarbon polymers substituted with high dielectric constant groups such as nitriles, carbonates, and sulfones, and combinations thereof. The linear polymers can also be used in combination as graft copolymers with polysiloxanes, polyalkoxysiloxanes, polyphosphazines, polyolefins, and/or polydienes to form the conductive phase. The structural phase may be made of polymers such as polystyrene, hydrogenated polystyrene, polymethacrylate, poly(methyl methacrylate), polyvinylpyridine, polyvinylcyclohexane, polyimide, polyamide, polypropylene, polyolefins, poly(t-butyl vinyl ether), poly(cyclohexyl methacrylate), poly(cyclohexyl vinyl ether), poly(t-butyl vinyl ether), polyethylene, poly(phenylene oxide), poly(2,6-dimethyl-1,4-phenylene oxide) (PXE), poly(phenylene sulfide), poly(phenylene sulfide sulfone), poly(phenylene sulfide ketone), poly(phenylene sulfide amide), polysulfone, fluorocarbons, such as polyvinylidene fluoride, or copolymers that contain styrene, methacrylate, or vinylpyridine. It is especially useful if the structural phase is rigid and is in a glassy or crystalline state. In various arrangements, the polymer electrolyte 230 has a molecular weight greater than 250 Da, greater than 1,000 Da, greater than 5,000 Da, greater than 10,000 Da, greater than 20,000 Da, greater than 100,000 Da, or any range subsumed therein. Further information about such block copolymer electrolytes can be found in U.S. Pat. No. 9,136,562, issued Sep. 15, 2015, U.S. Pat. No. 8,889,301, issued Nov. 18, 2014, U.S. Pat. No. 8,563,168, issued Oct. 22, 2013, and U.S. Pat. No. 8,268,197, issued Sep. 18, 2012, all of which are included by reference herein.

With respect to the embodiments discussed in FIGS. 3, 4, 5, and 6, organic liquid electrolytes for use in separator regions 360, 460, 560, 660, and as the anode overcoat layer 562 can be any ionically-conductive liquid electrolyte that is appropriate for use in a Li battery. Examples of liquid electrolytes that can be used in a composite organic-ceramic electrolyte have been listed above with reference to Table III. In general, liquid electrolytes may be used in combination to form electrolyte mixtures. As is well known in the art, batteries with organic liquid electrolytes may be used with an inactive separator membrane that is distinct from the organic liquid electrolyte.

With respect to the embodiments discussed in FIGS. 3, 4, 5, and 6, organic gel electrolytes for use in separator regions 360, 460, 560, 660, and as the anode overcoat layer 562 can any ionically-conductive gel electrolyte that is appropriate for use in a Li battery. Examples of gel electrolytes that can be used in a composite organic-ceramic electrolyte include, but are not limited to, polymers such as polyethylene oxide (PEO), polyacrylonitrile (PAN), poly(methyl methacrylate) (PMMA), poly(vinylidene fluoride) (PVDF), poly(vinyl pyrrolidinone) (PVP), poly(vinyl acetate) (PVAC), poly(vinylidene fluoride)-co-hexafluoropropylene (PVDF-HFP), and combinations thereof mixed with a liquid electrolyte such as those listed in Table III above.

### Examples

The following example provides details relating to fabrication and performance characteristics of a composite organic-ceramic electrolyte in accordance with the present invention. It should be understood the following is representative only, and that the invention is not limited by the detail set forth in this example.

Lithium symmetric cells were prepared with solid polymer electrolyte/ceramic electrolyte/solid polymer electrolyte stacks between lithium electrodes using three different types of ceramic electrolyte. The ceramic electrolyte in Cell 1 was an LLTO pellet that had been sintered in air at 1100° C. for 12 hours. The ceramic electrolyte in Cell 2 was the same LLTO but had been sintered in nitrogen at 1100° C. for 24 hours instead of in air. The solid polymer electrolytes were the same and were PEO/PS block copolymer electrolyte with LiTFSI salt.

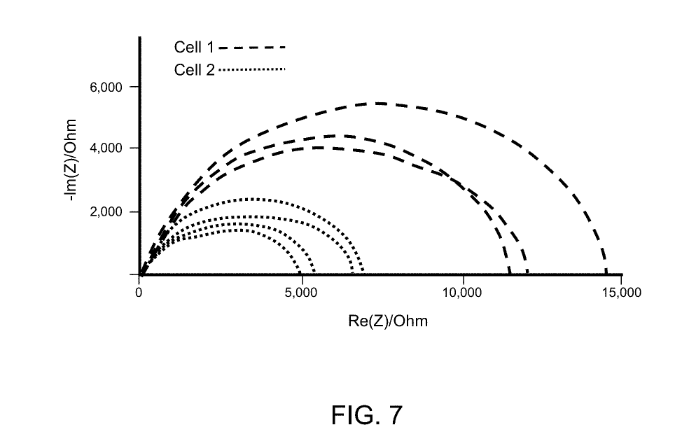

The resistance to ionic charge transport across the interface between the polymer electrolyte and the ceramic electrolyte was measured using AC impedance spectroscopy. FIG. 7 is Nyquist plot that shows AC impedance spectra for the two lithium symmetric cells. The Nyquist plot shows the negative imaginary portion of the impedance, which is related to capacitance as a function of the real portion of impedance, which is related to resistance. The larger the diameter of the semicircular plot, the larger the resistance to charge transfer through the cell. Cell 1 has the poorest charge transfer, and Cell 2 had much better charge transfer, indicating that resistance across the interface between the polymer electrolyte and the ceramic electrolyte was lower when the ceramic electrolyte material was sintered in nitrogen.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. A composite organic-ceramic electrolyte, comprising:
an organic electrolyte; and
core/shell particles dispersed throughout the organic electrolyte;
wherein the core/shell particles comprise:
a core particle comprising an ionically-conductive ceramic electrolyte material that has a capacity less than 50 mAh/g between 3V and 4.5 V vs. Li/Li⁺, an electronic conductivity less than 10⁻⁶ S/cm at 30° C., and an ionic conductivity greater than 10⁻⁷ S/cm at 30° C.; and
an electronically-conductive outer shell around the core particle, the electronically-conductive outer shell having an electronic conductivity greater than 1×10⁻⁴ S/cm at 30° C.

2. The composite organic-ceramic electrolyte of claim 1 wherein the ionic conductivity of the ceramic electrolyte is greater than the ionic conductivity of the organic electrolyte.

3. The composite organic-ceramic electrolyte of claim 1 wherein the ceramic electrolyte is selected from the group consisting of lithium lanthanum titanates, lithium lanthanum zirconium oxides, lithium nitrides, lithium aluminas, lithium vanadium germanium oxides, lithium silicon aluminum oxides, lithium aluminum chlorides, lithium phosphorous oxy-nitrides, LISICON, lithium aluminum titanium phosphates, lithium aluminum germanium phosphates, thio-LISICONs, lithium phosphorus sulfides, lithium germanium sulfides, and combinations thereof.

4. The composite organic-ceramic electrolyte of claim 1 wherein the organic electrolyte is selected from the group consisting of solid polymer electrolytes, gel electrolytes, and liquid electrolytes.

5. The composite organic-ceramic electrolyte of claim 1 wherein the solid polymer electrolyte comprises an electrolyte salt and a polymer selected from the group consisting of polyethers, polyamines, polyimides, polyamides, poly alkyl carbonates, polynitriles, perfluoro polyethers, polysiloxanes, polyalkoxysiloxanes, polyphosphazines, polyolefins, polydienes, polyesters, fluorocarbon polymers substituted with one or more groups selected from the group consisting of nitriles, carbonates, and sulfones, and combinations thereof.

6. The composite organic-ceramic electrolyte of claim 5 wherein the solid electrolyte has a molecular weight greater than 250 Da.

7. The composite organic-ceramic electrolyte of claim 1 wherein the liquid electrolyte comprises an electrolyte salt and a liquid selected from the group consisting of polyethylene glycol dimethyl ether, diethyl carbonate, ethylene carbonate, propylene carbonate, dimethylformamide, dimethylcarbonate, acetonitrile, succinonitrile, glutaronitrile, adiponitrile, alkyl substituted pyridinium-based ionic liquids, alkyl substituted pryrolidinium-based ionic liquids, alkyl substituted ammonium-based ionic liquids, alkyl substituted piperidinium-based ionic liquids, and combinations thereof.

8. The composite organic-ceramic electrolyte of claim 1 wherein the core/shell particles are approximately spherical and have average diameters between 10 nm and 100 μm.

9. The composite organic-ceramic electrolyte of claim 1 wherein the electronically-conductive outer shell is an electronically-conductive ceramic.

10. The composite organic-ceramic electrolyte of claim 9 wherein the electronically-conductive ceramic comprises nitrogen.

11. The composite organic-ceramic electrolyte of claim 1 wherein the electronically-conductive outer shell comprises a material selected from the group consisting of carbon, platinum, gold, silver, titanium, nickel, chrome, copper, aluminum, and combinations thereof.

12. The composite organic-ceramic electrolyte of claim 1 wherein the electronically-conductive outer shell comprises an electronically-conductive ceramic selected from the group consisting of titanium nitride, zirconium nitride, titanium fluoride, titanium phosphide, zirconium phosphide, zirconium chloride, titanium chloride, titanium bromide, zirconium bromide, iron phosphide, indium tin oxide, lanthanum-doped strontium titanate, yttrium-doped strontium titanate, lithium nickel cobalt aluminum oxide, lithium nickel cobalt manganese oxide, and combinations thereof.

13. The composite organic-ceramic electrolyte of claim 1 wherein the electronically-conductive outer shell comprises an electronically-conductive polymer selected from the group consisting of poly(acetylene)s, poly(p-phenylene vinylene)s, poly(pyrrole)s, polycarbazoles, polyindoles, polyazepines, polyanilines, poly(thiophene)s, poly(p-phenylene sulfide)s, poly(fluorene)s, polyphenylenes, polypyrenes, polyazulenes, polynaphthalenes, and combinations thereof.

14. A composite organic-ceramic electrolyte, comprising:
an organic electrolyte; and
core/shell particles dispersed throughout the organic electrolyte;
wherein the core/shell particles comprise:
a lithium lanthanum titanate core; and
a titanium nitride shell around the core.

15. A cathode comprising:
cathode active material particles, an electronically-conductive additive, a catholyte, and an optional binder material; and
a current collector adjacent to an outside surface of the cathode;
wherein the catholyte comprises a composite organic-ceramic electrolyte according to claim 1.

16. The cathode of claim 15 wherein the cathode active material particles comprise a material selected from the group consisting of lithium iron phosphate, lithium manganese phosphate, lithium cobalt phosphate, lithium nickel phosphate, lithium nickel cobalt aluminum oxide, lithium nickel cobalt manganese oxide, high-energy lithium nickel cobalt manganese oxide, lithium manganese spinel, lithium manganese nickel spinel, sulfur, vanadium pentoxide, and combinations thereof.

17. An electrochemical cell, comprising:
an anode configured to absorb and release lithium ions;
a cathode comprising cathode active material particles, an electronically-conductive additive, a first catholyte, and an optional binder material;
a current collector adjacent to an outside surface of the cathode; and
a separator region between the anode and the cathode, the separator region comprising a separator electrolyte configured to facilitate movement of lithium ions back and forth between the anode and the cathode;
wherein the first catholyte comprises a composite organic-ceramic electrolyte according to claim 1.

18. The electrochemical cell of claim 17 wherein the anode comprises graphite, silicon or lithium titanate, and the separator electrolyte comprises a composite organic-ceramic electrolyte according to claim 1.

19. The electrochemical cell of claim 17 wherein the anode comprises lithium or lithium alloy foil, the separator electrolyte comprises a composite organic-ceramic electrolyte according to claim 1, and further comprising an anode overcoat layer adjacent to the anode, wherein the anode overcoat layer comprises an electrolyte that contains no core/shell ceramic electrolyte particles.

20. The electrochemical cell of claim 17 further comprising a layer of second catholyte between the cathode and the separator electrolyte, wherein the second catholyte comprises a composite organic-ceramic electrolyte according to claim 1.

21. The electrochemical cell of claim 20 wherein the first catholyte and the second catholyte are the same.

22. The electrochemical cell of claim 17 further comprising a second catholyte layer between the cathode and the separator electrolyte, wherein the second catholyte layer comprises a ceramic electrolyte.

23. The electrochemical cell of claim 22 wherein the second catholyte layer further comprises one or more electronically-conductive surface layers, wherein the one or more electronically-conductive surface layers each has a thickness of 50 nm or less.
